(19) United States
(12) Patent Application Publication
(10) Pub. No.: US 2006/0159888 A1
(43) Pub. Date: Jul. 20, 2006

(54) Optical films incorporating cyclic olefin copolymers

(76) Inventors: Timothy J. Hebrink, Scandia, MN (US); Joan M. Strobel, Maplewood, MN (US); Barry S. Rosell, Lake Elmo, MN (US); Kevin M. Hamer, St. Paul, MN (US); Kristopher J. Derks, Woodbury, MN (US); Robert D. Taylor, Stacy, MN (US); Ronald R. Borst, Hastings, MN (US); Ellen R. Bosl, Eagan, MN (US); Bert T. Chien, St. Paul, MN (US); Carsten Franke, St. Paul, MN (US); Gregg A. Patnode, Woodbury, MN (US); Kevin R. Schaffer, Woodbury, MN (US)

Correspondence Address: 3M INNOVATIVE PROPERTIES COMPANY, PO BOX 33427, ST. PAUL, MN, 55133-3427, US

(21) Appl. No.: 11/250,765

(22) Filed: Oct. 14, 2005

Related U.S. Application Data
(60) Provisional application No. 60/623,431, filed on Oct. 29, 2004.

(51) Int. Cl. G11B 5/64

(52) U.S. Cl. 428/141

(57) ABSTRACT

The present disclosure relates to optical bodies including one or more norbornene-based cyclic olefin film layers and one or more rough strippable skin layers operatively connected to a surface of the norbornene-based cyclic olefin film layer. The rough strippable skin layer comprises a continuous phase and a disperse phase. Methods of producing such optical bodies are also disclosed.

### CROSS REFERENCE TO RELATED APPLICATIONS

This application claims priority of U.S. Application No. 60/623,431, filed Oct. 29, 2004, now pending, the disclosure of which is hereby incorporated by reference herein.

### FIELD OF THE INVENTION

The present disclosure relates to optical bodies including cyclic olefin copolymers and rough strippable skins and methods of producing such optical bodies.

### BACKGROUND OF THE INVENTION

Optical films, including optical brightness enhancement films, are widely used for various purposes. Exemplary applications include compact electronic displays, including liquid crystal displays (LCDs) placed in mobile telephones, personal data assistants, computers, televisions and other devices. Such films include Vikuiti™ Brightness Enhancement Film (BEF), Vikuiti™ Dual Brightness Enhancement Film (DBEF) and Vikuiti™ Diffuse Reflective Polarizer Film (DRPF), all available from 3M Company. Other widely used optical films include reflectors, such as Vikuiti™ Enhanced Specular Reflector (ESR).

Although polymeric optical films can have favorable optical and physical properties, one limitation with some such films is that they sometimes may show significant dimensional instability when exposed to fluctuations in temperature—even the temperature fluctuations experienced in normal use. This dimensional instability can result in formation of wrinkles in the film, which may be visible in LCDs as shadows. Such dimensional instability is particularly common when temperatures approach or exceed approximately 85° C. Dimensional instability is also observed when some types of films are cycled to high temperature and high humidity conditions, such as conditions of 60° C. and 70 percent relative humidity.

Another limitation of some optical films is that they can incur damage to their surfaces, such as scratching, denting and particle contamination, during manufacturing, handling and transport. Such defects can render the optical films unusable or can necessitate their use only in combination with additional diffusers in order to hide the defects from the viewer. Eliminating, reducing or hiding defects on optical films and other components is particularly important in displays that are typically viewed at close distance for extended periods of time. It is also useful to hide lighting components positioned behind the optical films, such as fluorescent tubes or LED lights.

### SUMMARY

In one exemplary implementation, the present disclosure is directed to optical bodies including a norbornene-based cyclic olefin film layer and at least one rough strippable skin layer operatively connected to a surface of the norbornene-based cyclic olefin film layer. The at least one rough strippable skin layer includes a continuous phase and a disperse phase.

In another exemplary implementation, the present disclosure is directed to optical bodies including a norbornene-based cyclic olefin film layer and at least one rough strippable skin layer operatively connected to the norbornene-based cyclic olefin film layer. In these exemplary embodiments, the at least one rough strippable skin layer includes a first polymer, a second polymer different from the first polymer, and an additional material that is substantially immiscible in at least one of the first and second polymers.

In yet another exemplary implementation, the present disclosure is directed to methods of imparting haze to a norbornene-based cyclic olefin film layer. Exemplary methods include operatively connecting at least one rough strippable skin layer to the norbornene-based cyclic olefin film, wherein the rough strippable skin layer comprises a continuous phase and a disperse phase, and imparting a texture corresponding to a texture of the rough strippable skin layer to the norbornene-based cyclic olefin layer.

### DESCRIPTION OF THE DRAWINGS

So that those of ordinary skill in the art to which the subject invention pertains will more readily understand how to make and use the subject invention, exemplary embodiments thereof are described in detail below with reference to the drawings, wherein:

FIG. 1 is a schematic partial cross-sectional view of an optical body constructed in accordance with an exemplary embodiment of the present disclosure, showing an optical film and two rough strippable skin layers disposed on two opposite surfaces of the optical film;

FIG. 2 is a schematic partial cross-sectional view of an optical body constructed in accordance with another exemplary embodiment of the present disclosure, showing an optical film and one rough strippable skin layer disposed on a surface of the optical film;

FIG. 3 is a schematic partial cross-sectional view of an optical body constructed in accordance with yet another embodiment of the present disclosure, showing an optical film, one strippable skin layer disposed on a surface of the optical film and a smooth outer skin layer;

FIG. 4 shows schematically a cross-sectional view of the configuration of Examples 1-8;

FIG. 5 is a representative digital photomicrograph produced using secondary electron imaging (SEI) at a viewing angle of 45° off the surface of a norbornene-based cyclic olefin layer to image surface morphology after removing the strippable skin layer;

FIG. 6 is a representative digital photomicrograph produced using secondary electron imaging (SEI) at a viewing angle of 45° off the surface of the strippable skin layer that was removed from the norbornene-based cyclic olefin layer in FIG. 5 to image surface morphology;

FIG. 7 shows schematically a cross-sectional view of the configuration of Prophetic Example 10.

### DETAILED DESCRIPTION

As summarized above, the present disclosure provides an optical body that includes one or more rough strippable skin layers that are operatively connected to an optical film. Such rough strippable skin layers can be used to impart a surface texture onto an optical film, for example, by co-extruding or orienting the optical film with the rough strippable skin layers or by another suitable method. The surface texture can include surface structures, and, in some exemplary embodiments, asymmetric surface structures. In some applications, such asymmetric surface structures can provide improved optical performance of the optical body. Optical bodies including rough strippable skin layers and methods of making such optical bodies are described in a co-owned application entitled “Optical Bodies and Methods for Making Optical Bodies,” U.S. application Ser. No. 10/977,211, Filed Oct. 29, 2004, the disclosure of which is hereby incorporated by reference herein.

In general, the strippable skin layers of the present disclosure are operatively connected to the optical films, so that they are capable of remaining adhered to the optical film during initial processing, storage, handling, packaging, transporting and subsequent processing, but can then be stripped or removed by a user. For example, the strippable skin layers can be removed immediately prior to installation into an LCD without applying excessive force, damaging the optical film or contaminating it with a substantial residue of skin particles.

The present disclosure is also directed to optical films composed of or including at least one layer of norbornene-based cyclic olefin copolymers. Norbornene-based cyclic olefin copolymers are unique materials that show promise in a number of electronic/optical/display applications. They are optically transparent, have good light stability including UV light stability, have very low birefringence and good moisture barrier properties. They are also dimensionally stable (i.e., glass transition temperatures from about 100° C. to about 160° C., high stiffness, and very low moisture absorption). Norbornene-based cyclic olefin layers applied to optical films provide dimensional stability and resistance to warping of the optical film.

The optical body that is formed using norbornene-based cyclic olefin layers is typically flexible, such that the optical body can be processed using conventional web handling equipment without damage. Inclusion of one or more norbornene-based cyclic olefin layers in an optical body will resist deformation of the optical body during heat and humidity exposure, while still allowing easy handling and storage of the optical body, such as by being wound and stored on a roll. The addition of one or more norbornene-based cyclic olefin layers in an optical body typically permits an optical body to be repeatedly cycled through a temperature of −35° C. to 85° C. every 2 hours for 192 hours without significant deterioration. These cycling tests are designed to be indicative of long term stability under expected use conditions in an LCD display or other device. Optical bodies including rough strippable skin layers and methods of making such optical bodies are described in a concurrently filed co-owned application entitled “Optical Films Incorporating Cyclic Olefin Copolymers,” U.S. application Ser. No. 10/976,675, filed Oct. 29, 2004, the disclosure of which is hereby incorporated by reference herein.

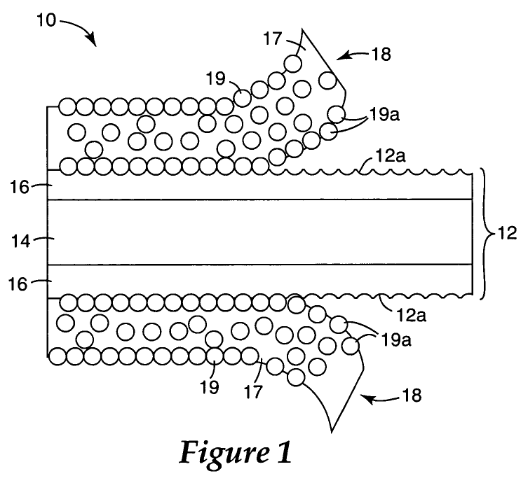

Reference is now made to the drawings, which show further aspects of the disclosure. FIGS. 1, 2 and 3 show example embodiments of the present disclosure in simplified schematic form. In FIG. 1, an optical body 10 constructed according to an exemplary embodiment of the present disclosure is depicted in simplified schematic form, and includes an optical film 12 and at least one rough strippable skin layer 18 disposed on one or two opposing surfaces of the optical film 12. The rough strippable skin layer or layers 18 are typically deposited onto the optical film 12 by co-extrusion or by other suitable methods, such as coating, casting or lamination. Some suitable methods of making exemplary optical bodies according to the present disclosure require or at least benefit from pre-heating of the film.

In some exemplary embodiments, the strippable skin layers can be formed directly on the optical film. During deposition of the strippable skin layers onto the optical film, after such deposition, or during subsequent processing, the rough strippable skin layers 18 can impart a surface texture including depressions 12a on the optical film 12. Thus, in typical embodiments of the present disclosure, at least a portion of a disperse phase 19 will form protrusions 19a projecting from the surface of the rough strippable skin layers 18, capable of patterning the optical film 12 with the surface structure having depressions 12a corresponding to protrusions 19a when the optical body 10 is extruded, oriented or otherwise processed. The optical film 12 can include a film body 14 and one or more optional under-skin layers 16. One or more of the underskin layers may include a norbornene-based cyclic olefin copolymer.

In the depicted embodiment, the rough strippable skin layers 18 include a continuous phase 17 and a disperse phase 19. The disperse phase 19 can be formed by blending particles in the continuous phase 17 or by mixing in a material or materials that are immiscible in the continuous phase 17 at the appropriate stages of processing, which preferably then phase-separate and form a rough surface at the interface between the strippable skin material and the optical film. The continuous phase 17 and disperse phase 19 are shown in a generalized and simplified view in FIG. 1, and in practice the two phases can be less uniform and more irregular in appearance. The degree of phase separation of the immiscible polymers depends upon the driving force for separation, such as extent of compatibility, extrusion processing temperature, degree of mixing, quenching conditions during casting and film formation, orientation temperatures and forces, and subsequent thermal history. In some exemplary embodiments, the rough strippable skin layer 18 may contain multiple sub-phases of the disperse or/and the continuous phase.

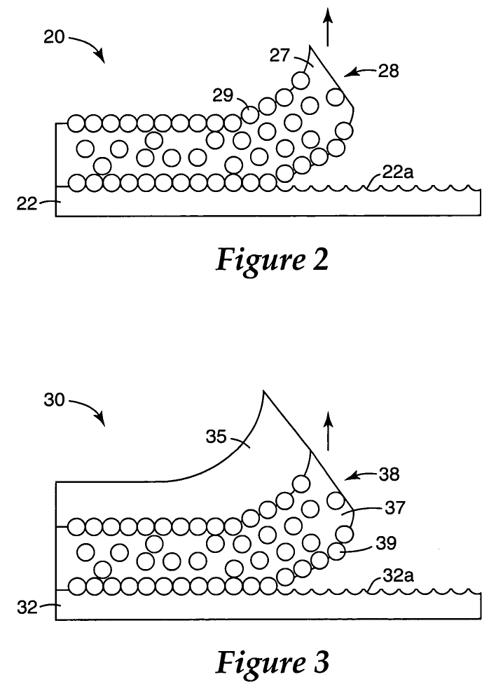

In FIG. 2, an optical body 20 constructed according to another exemplary embodiment of the present disclosure includes an optical film 22 and one rough strippable skin layer 28 disposed on a surface of an optical film 22. In this exemplary embodiment, the optical film 22 is comprised of a layer including a norbornene-based cyclic olefin copolymer. During the deposition of the rough skin layers onto the optical film, after such deposition or during subsequent processing of the optical body, such as lamination, co-extrusion or orientation, the rough strippable skin layer 28 imparts a surface texture including depressions 22a on the optical film 22. The rough strippable skin layer 28 includes a continuous phase 27 and a disperse phase 29.

In FIG. 3, an optical body 30 constructed according to yet another exemplary embodiment of the present disclosure includes an optical film 32 and one rough strippable skin layer 38 disposed on a surface of the optical film 32. In this exemplary embodiment, the optical film 32 is also comprised of a layer including a norbornene-based cyclic olefin copolymer. During the deposition of the rough skin onto the optical film, after such deposition or during subsequent processing, such as co-extrusion, orientation or lamination, the rough strippable skin layer 38 imparts a surface texture including depressions 32a on the optical film 32. In this exemplary embodiment, the rough strippable skin layer 38 includes a continuous phase 37, a disperse phase 39 and a smooth outer skin layer 35, which can be formed integrally and removed with the rest of the rough strippable skin layer 38. Alternatively, the smooth outer skin layer 35 can be formed and/or removed separately from the rough strippable skin layer 38. In some exemplary embodiments, the smooth outer skin layer 35 can include at least one of the same materials as the continuous phase 37. The smooth outer skin layer may be beneficial in reducing the extruder die lip buildup and flow patterns that can be caused by the material of the disperse phase 39. The layers depicted in FIGS. 1, 2 and 3 can be constructed to have different relative thicknesses than those illustrated.

Additional aspects of the disclosure will now be explained in greater detail.

### Strippable Skin Layers

The optical bodies of the present disclosure are formed with a strippable skin layer or layers, typically a rough strippable skin layer or layers. According to the present disclosure, the interfacial adhesion between the rough strippable skin layer(s) and the optical film can be controlled so that the rough strippable skin layers are capable of being operatively connected to the optical film, i.e., can remain adhered to the optical film for as long as desired for a particular application, but can also be cleanly stripped or removed from the optical film before use without applying excessive force, damaging the optical film or significantly contaminating the optical film with the residue from the skin layers.

In addition, it is sometimes beneficial if the rough strippable skin layers have sufficient adhesion to the optical film that they can be re-applied, for example, after inspection of the optical film. In some exemplary embodiments of the present disclosure, the optical bodies with the rough strippable skins operatively connected to the optical film are substantially transparent or clear, so that they can be inspected for defects using standard inspection equipment. Such exemplary clear optical bodies usually have rough strippable skins in which disperse and continuous phases have approximately the same or sufficiently similar refractive indexes. In some exemplary embodiments of such clear optical bodies, the refractive indexes of the materials making up the disperse and continuous phases differ from each other by no more than about 0.02.

It has been found that the operative connection of the at least one rough strippable skin layer to an adjacent surface of an optical film, included in the optical bodies of the present disclosure, is likely to have advantageous performance characteristics if the materials of the rough strippable skin layers can be selected so that the adhesion of the skin(s) to the optical films is characterized by a peel force of at least about 1.5 g/in or more or about 2 g/in or more. Other exemplary optical bodies constructed according to the present disclosure should be such that the peel force is at least about 3, 4, 5, 10 or 15 g/in or more. In some exemplary embodiments, the peel force could be about 100 g/in, about 120 g/in or more. Some desirable peel force values include about 50, 35, 30 or 25 g/in or less. Some desirable approximate ranges for adhesion include from 1.5 g/in to 120 g/in, from 2 g/in to 50 g/in, from 5 g/in to 35 g/in, or from 15 g/in to 25 g/in. In other exemplary embodiments, the adhesion can be within other suitable ranges.

Lower peel forces, for example, peel forces less than 120 g/in, are desirable in applications where a rough strippable skin is intended to be removed by hand or by other means that do not generate high forces. Higher peel forces in excess of 120 g/in may be acceptable, for example, where the rough strippable skin is intended to be removed by a machine. In the embodiments characterized by higher peel forces, removal of large areas of rough strippable skins may sometimes also be accomplished by the use of a machine.

The peel force that can be used to characterize exemplary embodiments of the present disclosure can be measured as follows. In particular, the present test method provides a procedure for measuring the peel force needed to remove a strippable skin layer from an optical film (e.g., multilayer film, norbornene-based cyclic olefin copolymer film, etc.).

Test-strips are cut from the optical body with a rough strippable skin layer adhered to the optical film. The strips are typically about 1″ in width, and more than about 6″ in length. The strips may be pre-conditioned for environmental aging characteristics (e.g., at temperatures of 85° C., 65° C. and 70% relative humidity (RH), −40° C., or after cycled for 192 hours from −35° C. to 85° C. in step increments followed by holding at each temperature for one hour. The last condition is sometimes referred to as thermal shock). Typically, the samples should dwell for more than about 24 hours while held at room temperature and 50% RH prior to testing. The 1″ strips are then applied to rigid plates, for example, using double-sided tape (such as Scotch™ double sided tape available from 3M), and the plate/test-strip assembly is fixed in place on the peel-tester platen.

The leading edge of the rough strippable skin is then separated from the optical film and clamped to a fixture connected to the peel-tester load-cell. The platen holding the plate/test-strip assembly is then carried away from the load-cell at constant speed of about 90 inches/minute, effectively peeling the strippable skin layer from the substrate optical film at about a 180 degree angle. As the platen moves away from the clamp, the force required to peel the strippable skin layer off the film is sensed by the load cell and recorded by a microprocessor. The force required for peel is then averaged over 5 seconds of steady-state travel (preferably ignoring the initial shock of starting the peel) and recorded.

It has been found that advantageous performance of exemplary optical bodies constructed according to the present disclosure can be accomplished by careful selection of the materials for making the continuous phase and the disperse phase and ensuring their compatibility with at least some of the materials used to make the optical film, especially the materials of the outer surfaces of the optical film or, in the appropriate embodiments, of the under-skin layers. In accordance with one implementation of the present disclosure, the continuous phase of the rough strippable skin layers should have low crystallinity or be sufficiently amorphous in order to remain adhered to the optical film for a desired period of time. However, in some exemplary embodiments, the continuous phase may also exhibit higher levels of crystallinity. Other variables have also been found to influence adhesion.

Thus, in the appropriate embodiments of the present disclosure, the degree of adhesion of the rough strippable skin layers to an adjacent surface or surfaces of the optical film, as well as the degree of surface roughness, can be adjusted to fall within a desired range by blending in more crystalline or less crystalline materials, more adhesive or less adhesive materials, or by promoting crystallinity in one or more of the materials through subsequent processing steps. In some exemplary embodiments, two or more different materials with different adhesions can be used as co-continuous phases included into the continuous phase of the rough strippable skin layers of the present disclosure. Nucleating agents can also be blended into the rough strippable skin layers in order to adjust the rate of crystallization of one or more of the phases in the strippable skin composition. In some exemplary embodiments, pigments, dyes or other coloring agents can be added to the materials of the rough strippable skins for improved visibility of the skin layers.

Furthermore, it has been found that factors other than crystallinity can affect peel adhesion and surface roughness. These other factors may have larger or smaller effects than crystallinity. One such factor is polarity. In accordance with one implementation of the present disclosure, the continuous phase of the rough strippable skin layers should have sufficiently different polarity than the optical film in order for it to have peel force values within suitable ranges. For example, norbornene-based cyclic olefin copolymers are generally non-polar.

The degree of surface roughness of the rough strippable skin layers can be adjusted similarly by mixing or blending different materials, for example, polymeric materials, inorganic materials, or both into the disperse phase. In addition, the ratio of disperse phase to continuous phase can be adjusted to control the degree of surface roughness and adhesion and will depend on the particular materials used. Thus, one, two or more polymers would function as the continuous phase, while one, two or more materials, which may or may not be polymeric, would provide a disperse phase with a suitable surface roughness for imparting a surface texture. The one or more polymers of the continuous phase can be selected to provide a desired adhesion to the material of the optical film.

Where the disperse phase is capable of crystallization, the roughness of the strippable skin layer or layers can be enhanced by crystallization of this phase at an appropriate extrusion processing temperature, degree of mixing, and quenching, as well as through addition of nucleation agents, such as aromatic carboxylic-acid salts (sodium benzoate); dibenzylidene sorbitol (DBS), such as Millad 3988 from Milliken & Company; and sorbitol acetals, such as Irgaclear clarifiers by Ciba Specialty Chemicals and NC-4 clarifier by Mitsui Toatsu Chemicals. Other nucleators include organophosphate salts and other inorganic materials, such as ADKstab NA-11 and NA-21 phosphate esters from Asahi-Denka and Hyperform HPN-68, a norbornene carboxylic-acid salt from Milliken & Company. In some exemplary embodiments, the disperse phase includes particles, such as those including inorganic materials, that will protrude from the surface of the rough strippable skin layers and impart surface structures into the optical film when the optical body is processed, e.g., extruded, oriented or laminated together.

### Disperse Phase of Strippable Skin Layer

The disperse phase of the rough strippable skin layers can include particles or other rough features that are sufficiently large (for example, at least 0.1 micrometers average diameter) to be used to impart a surface texture into the outer surface of an adjacent layer of the optical film by application of pressure and/or temperature to the optical film with the rough strippable skin layer or layers. At least a substantial portion of protrusions of the disperse phase should typically be larger than the wavelength of the light it is illuminated with but still small enough not to be resolved with an unaided eye. Such particles can include particles of inorganic materials, such as silica particles, talc particles, sodium benzoate, calcium carbonate, a combination thereof or any other suitable particles. Alternatively, the disperse phase can be formed from polymeric materials that are (or become) substantially immiscible in the continuous phase under the appropriate conditions.

The disperse phase can be formed from one or more materials, such as inorganic materials, polymers, or both that are different from at least one polymer of the continuous phase and immiscible therein. Some disperse polymer phases have a higher degree of crystallinity than the polymer or polymers of the continuous phase. In some exemplary embodiments, the use of more than one material for the disperse phase can result in rough features or protrusions of different sizes or compounded protrusions, such as “protrusion-on-protrusion” configurations. Such constructions can be beneficial for creating hazier surfaces on optical films. It is preferred that the disperse phase is only mechanically miscible or immiscible with the continuous phase polymer or polymers. The disperse phase material or materials and the continuous phase material or materials can phase separate under appropriate processing conditions and form distinct phase inclusions within the continuous matrix, and particularly at the interface between the optical film and the rough strippable skin layer.

Exemplary materials that are particularly suitable for use in the disperse phase include styrene acrylonitrile copolymer, polystyrene, medium density polyethylene, modified polyethylene, polybutene-1, norbornene-based copolymers, polycarbonate and copolyester blend, ε-caprolactone polymer, such as TONE™ P-787, available from Dow Chemical Company, copolymers of propylene and ethylene, propylene homopolymers, other propylene copolymers, poly(ethylene octane) copolymers, polymers exhibiting anti-static characteristics, high density polyethylene, calcium carbonate (CaCO₃) and poly(methyl methacrylate). The disperse phase of the rough strippable skin layers may include any other appropriate material, such as any suitable crystallizing polymer and it may include the same materials as one or more of the materials used in the optical film.

### Continuous Phase of Strippable Skin Layer

Materials suitable for use in the continuous phase of the rough strippable skin layer include, for example, polyesters, such as polyethyleneterephthalate (PET), polybutyleneterephthalate (PBT); copolyesters, such as glycol-modified polyethyleneterephthalate (PETG); polyethylenenapththalates (PENs) and copolyethylenenapththalates (CoPENs); polyamides, such as nylon-6; and polycarbonates. Additionally, there are other materials that may be suitable in certain situations.

Other materials suitable for use in the continuous phase of the rough strippable skin layer include, for example, polyolefins, such as low melting and low crystallinity polypropylenes and their copolymers; low melting and low crystallinity polyethylenes and their copolymers, low melting and low crystallinity polyesters and their copolymers, or any suitable combination thereof. Such low melting and low crystallinity polypropylenes and their copolymers consist of propylene homopolymers and copolymers of propylene and ethylene or alpha-olefin materials having between 4 to 10 carbon atoms. The term “copolymer” includes not only the copolymer, but also terpolymers and polymers of four or more component polymers. Suitable low melting and low crystallinity polypropylenes and their copolymers include, for example, syndiotactic polypropylene (such as, Finaplas 1571 from Total Petrochemicals, Inc.), which is a random copolymer with an extremely low ethylene content in the syndiotactic polypropylene backbone, and random copolymers of propylene (such as PP8650 or PP6671 from Atofina, which is now Total Petrochemicals, Inc.). The described copolymers of propylene and ethylene can also be extrusion blended with homopolymers of polypropylene to provide a higher melting point skin layer if needed.

Other suitable low melting and low crystallinity polyethylenes and polyethylene copolymers include, for example, linear low density polyethylene and ethylene (vinyl alcohol) copolymers. Suitable polypropylenes include, for example, random copolymers of propylene and ethylene (for example, PP8650 from Total Petrochemicals, Inc.), ethylene octene copolymers (for example, Affinity PT 1451 from Dow Chemical Company), and include ethylene (vinyl acetate) copolymers. In some embodiments of the present disclosure, the continuous phase includes an amorphous polyolefin, such as an amorphous polypropylene, amorphous polyethylene, amorphous polyester, or any suitable combination thereof or with other materials. In some embodiments, the materials of the rough strippable skin layers can include nucleating agents, such as sodium benzoate to control the rate of crystallization. Additionally, anti-static materials, anti-block materials, coloring agents such as pigments and dyes, stabilizers, and other processing aids may be added to the continuous phase. Additionally or alternatively, the continuous phase of the rough strippable skin layers may include any other appropriate material. In some exemplary embodiments, migratory antistatic agents can be used in the rough strippable skin layers to lower their adhesion to the optical films.

The thickness of the rough strippable skin layer is typically from 0.5 mil to 6 mils. In some embodiments, it may be thicker or thinner.

### Norbornene-Based Layers and Optical Films Including Norbornene-Based Layers

In accordance with the present disclosure, norbornene-based cyclic olefin layers include norbornene-based polymers, such as, polymers, copolymers and polymer blends wherein one or more polymers contain norbornene or a norbornene-derivative. The properties described for layers (generally, one or more layers in or on a multilayer film), also apply to films (an independent norbornene-based cyclic olefin layer, not otherwise or yet associated with additional materials). Generally, the norbornene-based cyclic olefin layer is a co-polymer comprising a norbornene-based copolymer. The term “copolymer” includes polymers having two or more different monomeric units. Example monomers for norbornene-based copolymers include: norbornene, 2-norbornene (from ethylene and dicyclopentadiene), and derivatives thereof, polymerized with an olefin, such as ethylene. Ring-opening polymers based on dicyclopentadiene or related compounds may also be used. Norbornene derivatives include alkyl, alkylidene, and aromatic substituted derivatives, as well as halogen, hydroxy, ester, alkoxy, cyano, amide, imide and silyl substituted derivatives.

Additional examples of monomers that can be used for form norbornene-based copolymers include: 2-norbornene, 5-methyl-2-norbornene, 5,5-dimethyl-2-norbornene, 5-butyl-2-norbornene, 5-ethylidene-2-norbornene, 5-methoxycarbonyl-2-norbornene, 5-cyano-2-norbornene, 5-methyl-5-methoxycarbonyl-2-norbornene, and 5-phenyl-2-norbornene. Polymers of cyclopentadienes, and derivatives thereof, for example, dicyclopentadiene, and 2,3,-dihydrocyclopentadiene are also examples.

Commercially available norbornene-based copolymer blends include: Topas®, random ethylene norbornene copolymers available from Ticona, Summit, N.J.; Zeonor®, alicyclic cycloolefin copolymers available from Zeon Chemicals, Louisville, Ky.; Apel®, random ethylene norbornene copolymers from Mitsui Chemicals, Inc., Tokyo, Japan; and Arton® from JSR Corporation, Japan. Increasing the norbornene component of the copolymer increases the Tg. It has been found particularly useful that different grades of norbornene-based copolymers having high and low Tg's can be blended to adjust the composite Tg.

The polymer composition of the norbornene-based cyclic olefin layer is preferably selected such that it is substantially stable at temperatures from at least about −35° C. to 85° C. The norbornene-based cyclic olefin layer is normally flexible, but does not significantly expand in length or width over the temperature range of −35° C. to 85° C.

The norbornene-based cyclic olefin layer typically includes, as a primary component, a norbornene-based cyclic olefin copolymer material exhibiting a glass transition temperature (T_{g}) from 85 to 200° C., more typically from 100 to 160° C. In some embodiments, the norbornene-based cyclic olefin copolymer is selected such that it can be extruded and remains transparent after processing at high temperatures. A norbornene-based cyclic olefin film or layer is normally transparent or substantially transparent.

Various blends of Topas® polymers were prepared and evaluated by dynamic mechanical analysis. They are presented in Table 1. Each sample was scanned from 0 to 180° C. at a modulation frequency of 0.1 Hertz to determine the modulus as a function of temperature and glass transition temperature (T_{g}). The composition and physical properties of the norbornene-based copolymer blends are presented in Table 1.

TABLE 1

| | Modulus (25° C.) | Modulus (85° C.) | T_{g} |
|---|---|---|---|
| Sample Composition (%) | (GPa) | (GPa) | (° C.) |
| 45/55 Topas ® 8007/6013 | 2.18 | 1.21 | 99.0 |
| 30/70 Topas ® 8007/6013 | 2.21 | 1.63 | 110.0 |
| 15/85 Topas ® 8007/6013 | 2.20 | 1.59 | 124.0 |
| Topas ® 6013 | 2.46 | 1.91 | 137.0 |

The thickness of a norbornene-based cyclic olefin layer can vary depending upon the application. However, a norbornene-based cyclic olefin layer is typically from 0.1 to 15 mils (about 2 to 250 micrometers) thick.

Various optical films are suitable for use with the present disclosure. In particular, polymeric optical films, including oriented polymeric optical films, are suitable for use with the present disclosure because they may sometimes suffer from dimensional instability due to exposure to temperature fluctuations.

In particular, the norbornene-based cyclic olefins layers are suited for use with polymeric films that would benefit from dimensional stabilization. In some embodiments, a norbornene-based cyclic olefin is extrusion coated with an adhesive tie layer onto the optical film at temperatures exceeding 250° C. In other embodiments, the norbornene-based cyclic olefin layer is applied in a lamination process. In yet other embodiments of the present disclosure, a norbornene-based cyclic olefin layer, either after removal of the rough strippable skin layer or referring to the face opposite the rough strippable skin, is adhered to a layer of a curable material, as described in the co-owned application entitled “Optical Films Incorporating Cyclic Olefin Copolymers,” U.S. application Ser. No. 10/976,675, filed Oct. 29, 2004. Such layers of curable material can carry surface structures, such as prismatic structures, or can be in turn adhered to another layer or optical film, also as described in the same application.

The optical films 12, 22 and 32, respectively of FIGS. 1, 2, and 3, can include dielectric multilayer optical films (whether composed of all birefringent optical layers, some birefringent optical layers, or all isotropic optical layers), such as DBEF and ESR, and optical films containing a disperse phase and a continuous phase. Exemplary suitable continuous/disperse phase optical films include diffuse reflective polarizers, such as DRPF. The optical films 22 and 32 of the exemplary embodiments shown in FIGS. 2 and 3 can include a prismatic film, such as BEF, or another optical film having a structured surface and disposed so that the structured surface faces away from the rough strippable skin layer 28 or 38.

Those of ordinary skill in the art will readily appreciate that the structures, methods, and techniques described herein can be adapted and applied to other types of suitable optical films. The optical films specifically mentioned herein are merely illustrative examples and are not meant to be an exhaustive list of optical films suitable for use with exemplary embodiments of the present disclosure.

Exemplary optical films that are suitable for use in the present disclosure include multilayer reflective films such as those described in, for example, U.S. Pat. Nos. 5,882,774 and 6,352,761 and in PCT Publication Nos: WO95/17303; WO95/17691; WO95/17692; WO95/17699; WO96/19347; and WO99/36262, all of which are incorporated herein by reference. Both multilayer reflective optical films and continuous/disperse phase reflective optical films rely on index of refraction differences between at least two different materials (typically polymers) to selectively reflect light of at least one polarization orientation. Suitable diffuse reflective polarizers include the continuous/disperse phase optical films described in, for example, U.S. Pat. No. 5,825,543, incorporated herein by reference, as well as the diffusely reflecting optical films described in, for example, U.S. Pat. No. 5,867,316, incorporated herein by reference.

In some embodiments the optical film is a multilayer stack of polymer layers with a Brewster angle (the angle at which reflectance of p-polarized light turns to zero) that is very large or nonexistent. Multilayer optical films can be made into a multilayer mirror or polarizer whose reflectivity for p-polarized light decreases slowly with angle of incidence, is independent of angle of incidence, or increases with angle of incidence away from the normal. Multilayer reflective optical films are used herein as an example to illustrate optical film structures and methods of making and using the optical films of the disclosure. As mentioned above, the structures, methods, and techniques described herein can be adapted and applied to other types of suitable optical films.

For example, a suitable multilayer optical film can be made by alternating (e.g., interleaving) uniaxially- or biaxially-oriented birefringent first optical layers with second optical layers. In some embodiments, the second optical layers have an isotropic index of refraction that is approximately equal to one of the in-plane indices of the oriented layer. The interface between the two different optical layers forms a light reflection plane. Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers.

A film having multiple layers can include layers with different optical thicknesses to increase the reflectivity of the film over a range of wavelengths. For example, a film can include pairs of layers that are individually tuned (for normally incident light, for example) to achieve optimal reflection of light having particular wavelengths. Generally, multilayer optical films suitable for use with certain embodiments of the disclosure have about 2 to 5000 optical layers, typically about 25 to 2000 optical layers, and often about 50 to 1500 optical layers or about 75 to 1000 optical layers. It should further be appreciated that, although only a single multilayer stack may be described, the multilayer optical film can be made from multiple stacks or different types of optical film that are subsequently combined to form the film. The described multilayer optical films can be made according to U.S. Ser. No. 09/229,724 and U.S. Patent Application Publication No. 2001/0013668, which are both incorporated herein by reference.

A polarizer can be made by combining a uniaxially oriented first optical layer with a second optical layer having an isotropic index of refraction that is approximately equal to one of the in-plane indices of the oriented layer. Alternatively, both optical layers are formed from birefringent polymers and are oriented in a draw process so that the indices of refraction in a single in-plane direction are approximately equal. The interface between the two optical layers forms a light reflection plane for one polarization of light. Light polarized in a plane parallel to the direction in which the indices of refraction of the two layers are approximately equal will be substantially transmitted. Light polarized in a plane parallel to the direction in which the two layers have different indices will be at least partially reflected. For polarizers having second optical layers with isotropic indices of refraction or low in-plane birefringence (e.g., no more than about 0.07), the in-plane indices (nₓ and n_{y}) of refraction of the second optical layers are approximately equal to one in-plane index (e.g., n_{y}) of the first optical layers. Thus, the in-plane birefringence of the first optical layers is an indicator of the reflectivity of the multilayer optical film. Typically, it is found that the higher the in-plane birefringence, the better the reflectivity of the multilayer optical film. If the out-of-plane indices (n_{z}) of refraction of the first and second optical layers are equal or nearly equal (e.g., no more than 0.1 difference and preferably no more than 0.05 difference), the multilayer optical film also has better off-angle reflectivity.

A mirror can be made using at least one uniaxially birefringent material, in which two indices (typically along the x and y axes, or nₓ and n_{y}) are approximately equal, and different from the third index (typically along the z axis, or n_{z}). The x and y axes are defined as the in-plane axes, in that they represent the plane of a given layer within the multilayer film, and the respective indices nₓ and n_{y} are referred to as the in-plane indices. One method of creating a uniaxially birefringent system is to biaxially orient (stretch along two axes) the multilayer polymeric film. If the adjoining layers have different stress-induced birefringence, biaxial orientation of the multilayer film results in differences between refractive indices of adjoining layers for planes parallel to both axes, resulting in the reflection of light of both planes of polarization.

A uniaxially birefringent material can have either positive or negative uniaxial birefringence. Negative uniaxial birefringence occurs when the index of refraction in the z direction (n_{z}) is greater than the in-plane indices (nₓ and n_{y}). Positive uniaxial birefringence occurs when the index of refraction in the z direction (n_{z}) is less than the in-plane indices (nₓ and n_{y}). If n_{1z} is selected to match n₂ₓ=n_{2y}=n_{2z} and the first layers of the multilayer film is biaxially oriented, there is no Brewster's angle for p-polarized light and thus there is constant reflectivity for all angles of incidence. Multilayer films that are oriented in two mutually perpendicular in-plane axes are capable of reflecting an extraordinarily high percentage of incident light depending of the number of layers, f-ratio, indices of refraction, etc., and are highly efficient mirrors. The first optical layers are preferably birefringent polymer layers that are uniaxially- or biaxially-oriented. The birefringent polymers of the first optical layers are typically selected to be capable of developing a large birefringence when stretched. Depending on the application, the birefringence may be developed between two orthogonal directions in the plane of the film, between one or more in-plane directions and the direction perpendicular to the film plane, or a combination of these. The first polymer should maintain birefringence after stretching, so that the desired optical properties are imparted to the finished film. The second optical layers can be polymer layers that are birefringent and uniaxially- or biaxially-oriented, or the second optical layers can have an isotropic index of refraction that is different from at least one of the indices of refraction of the first optical layers after orientation. The second polymer advantageously develops little or no birefringence when stretched, or develops birefringence of the opposite sense (positive—negative or negative—positive), such that its film-plane refractive indices differ as much as possible from those of the first polymer in the finished film. For most applications, it is advantageous for neither the first polymer nor the second polymer to have any absorbance bands within the bandwidth of interest for the film in question. Thus, all incident light within the bandwidth is either reflected or transmitted. However, for some applications, it may be useful for one or both of the first and second polymers to absorb specific wavelengths, either totally or in part.

Materials suitable for making optical films for use in exemplary embodiments of the present disclosure include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof; t-butyl isophthalic acid, trimellitic acid, sodium sulfonated isophthalic acid; 2,2′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis (2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyethylene terephthalate (PET), and copolymers thereof.

A second polymer of the second optical layers should be chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,762 and 6,498,683 and U.S. patent application Ser. Nos. 09/229,724, 09/232,332, 09/399,531, and 09/444,756, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to the isotropic refractive index of the first polymer. Examples of other polymers suitable for use in optical films and, particularly, in the second optical layers, other than the CoPEN polymers discussed above, include vinyl polymers and copolymers made from monomers such as vinyl naphthalenes, styrene, maleic anhydride, acrylates, and methacrylates. Examples of such polymers include polyacrylates, polymethacrylates, such as poly (methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers and copolymers such as polyesters and polycarbonates.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008.

Yet other suitable polymers, especially for use in the second optical layers, include polyolefin copolymers such as poly (ethylene-co-octene) (PE-PO) available from Dow-Dupont Elastomers under the trade designation Engage 8200, poly (propylene-co-ethylene) (PPPE) available from Fina Oil and Chemical Co., Dallas, Tex., under the trade designation Z9470, and a copolymer of atactic polypropylene (aPP) and isotactic polypropylene (iPP), which was available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, and PET/sPS, where “co-PET” refers to a copolymer or blend based upon terephthalic acid (as described above), ECDEL is a thermoplastic polyester commercially available from Eastman Chemical Co., and THV is a fluoropolymer commercially available from 3M. PMMA refers to polymethyl methacrylate and PETG refers to a copolymer of PET employing a second glycol (usually cyclohexanedimethanol). sPS refers to syndiotactic polystyrene.

Optical films suitable for use with the disclosure are typically thin. Suitable films may have varying thickness, but particularly they include films with thicknesses of less than 15 mils (about 380 micrometers), more typically less than 10 mils (about 250 micrometers), and preferably less than 7 mils (about 180 micrometers). During processing, a dimensionally stable layer may be included into the optical film by extrusion coating or coextrusion at temperatures exceeding 250° C. The optical film also normally undergoes various bending and winding steps during processing, and therefore, in the typical exemplary embodiments of the present disclosure, the film should be flexible. Optical films suitable for use in the exemplary embodiments of the present disclosure can also include optional optical or non-optical layers, such as one or more protective boundary layers between packets of optical layers. The non-optical layers may be of any appropriate material suitable for a particular application and can be or can include at least one of the materials used in the remainder of the optical film.

In some exemplary embodiments, an intermediate layer or an underskin layer can be integrally formed with the optical film. One or more under-skin layers are typically formed by co-extrusion with the optical film, for example, to integrally form and bind the first and second layers. An intermediate layer can be integrally or separately formed on the optical film, for example, by being simultaneously co-extruded or sequentially extruded onto the optical film.

In typical embodiments of the present disclosure, roughness of the norbornene-based cyclic olefin film surface after the rough strippable skin layer(s) is/are removed should be sufficient to produce at least some haze or aid in reducing wet-out of the norbornene-based cyclic olefin films of the present disclosure against other components. Amounts of haze of a norbornene-based cyclic olefin film suitable for some exemplary embodiments include about 5% to about 95%, about 20% to about 80%, about 50% to about 90%, about 10% to about 30%, and about 35% to 80%. Other amounts of haze may be desired for other applications. In other exemplary embodiments, roughness of the norbornene-based cyclic olefin film surface after the rough strippable skin layers are removed should be sufficient to provide at least some redirection of light or to prevent coupling of the norbornene-based cyclic olefin film surface to glass or another surface. For example, surface structures of about 0.2 microns in size have been found sufficient for some applications.

### Material Compatibility and Methods

Preferably, the materials of the optical films, and in some exemplary embodiments, of the first optical layers, the second optical layers, the optional non-optical layers, and of the rough strippable skin layers are chosen to have similar rheological properties (e.g., melt viscosities) so that they can be co-extruded without flow instabilities. Typically, the second optical layers, optional other non-optical layers, and rough strippable skin layers have a glass transition temperature, T_{g}, that is either below or no greater than about 40° C. above the glass transition temperature of the first optical layers. Desirably, the glass transition temperature of the second optical layers, optional non-optical layers, and the rough strippable skin layers is below the glass transition temperature of the first optical layers. When length orientation (LO) rollers are used to orient multilayer optical film, it may not be possible to use desired low T_{g} skin materials, because the low T_{g} material will stick to the rollers. If LO rollers are not used, such as with a simo-biax tenter, then this limitation is not an issue.

In some implementations, when the rough strippable skin layer is removed, there will be no remaining material from the rough strippable skin layer or any associated adhesive, if used. Optionally, as explained above, the strippable skin layer includes a dye, pigment, or other coloring material so that it is easy to observe whether the strippable skin layer is still on the optical body or not. This can facilitate proper use of the optical body. The strippable skin layer typically has a thickness of at least 0.5 mils or 12 micrometers, but other thicknesses (larger or smaller) can be produced as desired for specific applications.

Various methods may be used for forming optical bodies of the present disclosure, which may include extrusion blending, coextrusion, film casting and quenching, lamination and orientation. As stated above, the optical bodies can take on various configurations, and thus the methods vary depending upon the configuration and the desired properties of the final optical body.

### EXAMPLES

Exemplary embodiments of the present disclosure can be constructed as described in detail in the following examples.

### Example 1

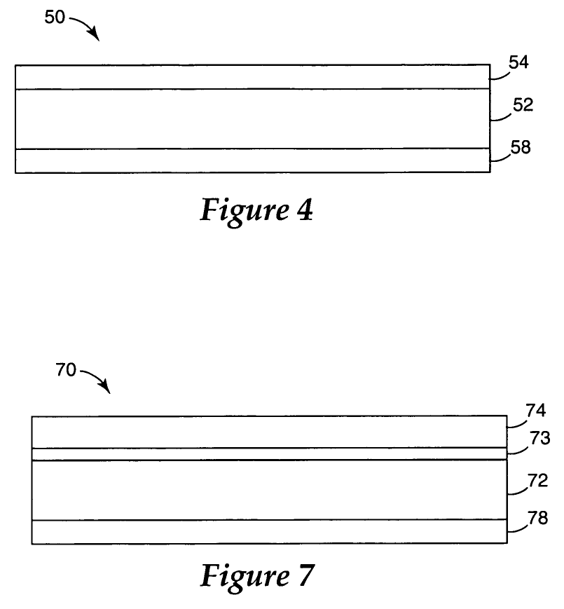

A three-layer, coextruded cast film was prepared, the general configuration of which is schematically illustrated in FIG. 4. The optical body 50 included a 1.5-mil-thick protective layer 54 of a glycol-modified polyester, Eastar 6763, from Eastman Chemicals. In this exemplary embodiment, the layers 54 and 58, function to prevent contamination or scratching of the adjacent surface of a norbornene-based cyclic olefin layer 52. Layers 54 and 58 also function as carrier layers for 52 in subsequent processing of the optical body, since some cyclic olefin copolymers are inherently quite brittle materials. The norbornene-based cyclic olefin layer 52 of the optical body 50 was a 2.0-mil-thick layer of Topas® cyclic olefin copolymer available from Ticona (Celanese). The norbornene-based cyclic olefin layer 52 also contained 0.25% of Palmowax® ethylene bis stearamide (EBS) lubricant from Acme-Hardesty, Inc. The rough strippable skin layer 58 of optical body 50 was a 1.5-mil-thick layer of Eastar 6763 containing 5% by weight of Polybatch DUL3636DP12 blend from A. Schulman, Inc. The Polybatch material is a 50%/50% blend of a random propylene copolymer and a medium-density polyethylene.

The three-layer film (optical body 50) was cast onto a chrome roll and was cooled to room temperature. The layers 58 and 54 were stripped from the norbornene-based cyclic olefin layer 52 to provide a cyclic olefin copolymer film having a haze level of 8%, as determined using a BYK-Gardner Hazegard Plus haze meter in accordance with the procedures described in ASTM D1003. The 180° peel force, as determined using the method described previously, required to peel the layer 58 from the norbornene-based cyclic olefin layer 52 was measured as 2.8 g/in.

A section was removed from five separate areas across the optical body 50. Layers 58 and 52 were separated from each of the removed sections and these were mounted on aluminum stubs to view the mating surfaces. All specimens were sputter coated with gold/palladium and were examined using the FEI XL30 Environmental Scanning Electron Microscope (ESEM), operating in high vacuum mode.

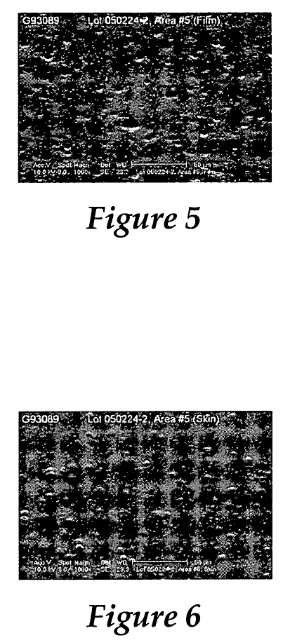

Representative digital photomicrographs, shown in FIGS. 5 and 6, were produced using secondary electron imaging (SEI) to image surface morphology. All micrographs were taken at a viewing angle of 45° off the surface of the surface of the film layer. FIG. 5 is a digital photomicrograph of norbornene-based cyclic olefin layer 52. FIG. 6 is a digital photomicrograph of rough strippable skin layer 58.

The surface topography of layer 52 and of layer 58 was determined using a Wyko NT-3300 Surface Profiling System. The instrument was operated using a 50× objective with a 0.5× multiplier in the full resolution VIS mode with a modulation threshold of 1%. Three areas on each sample were examined. Table 2 summarizes the results of the surface topography measurements.

TABLE 2

| Sample | | Pos | Area | Ra (um) | Rq (um) | Rp (um) | Rv (um) | Rt (um) | Rz (um) |
|---|---|---|---|---|---|---|---|---|---|
| COC film | substrate | 1 | 1 | 0.16 | 0.24 | 0.90 | −2.50 | 3.40 | 2.78 |
| COC film | substrate | 1 | 2 | 0.15 | 0.21 | 1.42 | −2.03 | 3.45 | 2.45 |
| COC film | substrate | 1 | 3 | 0.15 | 0.21 | 0.88 | −1.99 | 2.87 | 2.54 |
| Average | | | | 0.15 | 0.22 | 1.07 | −2.17 | 3.24 | 2.59 |
| St Dev | | | | 0.01 | 0.02 | 0.30 | 0.28 | 0.32 | 0.17 |
| COC film | substrate | 3 | 1 | 0.14 | 0.20 | 0.86 | −1.79 | 2.65 | 2.37 |
| COC film | substrate | 3 | 2 | 0.13 | 0.19 | 0.73 | −1.92 | 2.66 | 2.31 |
| COC film | substrate | 3 | 3 | 0.15 | 0.21 | 0.94 | −1.99 | 2.93 | 2.38 |
| Average | | | | 0.14 | 0.20 | 0.84 | −1.90 | 2.74 | 2.36 |
| St Dev | | | | 0.01 | 0.01 | 0.10 | 0.10 | 0.16 | 0.04 |
| COC film | substrate | 5 | 1 | 0.16 | 0.23 | 0.91 | −2.11 | 3.02 | 2.72 |
| COC film | substrate | 5 | 2 | 0.13 | 0.19 | 0.97 | −2.01 | 2.98 | 2.41 |
| COC film | substrate | 5 | 3 | 0.14 | 0.20 | 1.01 | −1.70 | 2.71 | 2.28 |
| Average | | | | 0.14 | 0.21 | 0.96 | −1.94 | 2.90 | 2.47 |
| St Dev | | | | 0.01 | 0.02 | 0.05 | 0.21 | 0.17 | 0.23 |
| COC film | skin | 1 | 1 | 0.15 | 0.23 | 2.59 | −0.74 | 3.33 | 2.77 |
| COC film | skin | 1 | 2 | 0.16 | 0.23 | 2.07 | −1.47 | 3.54 | 2.64 |
| COC film | skin | 1 | 3 | 0.14 | 0.21 | 1.82 | −0.63 | 2.45 | 2.24 |
| Average | | | | 0.15 | 0.23 | 2.16 | −0.95 | 3.11 | 2.55 |
| St Dev | | | | 0.01 | 0.01 | 0.39 | 0.46 | 0.58 | 0.27 |
| COC film | skin | 3 | 1 | 0.16 | 0.24 | 2.60 | −0.75 | 3.35 | 2.59 |
| COC film | skin | 3 | 2 | 0.15 | 0.22 | 2.16 | −0.62 | 2.78 | 2.42 |
| COC film | skin | 3 | 3 | 0.16 | 0.24 | 2.44 | −0.74 | 3.19 | 2.70 |
| Average | | | | 0.16 | 0.23 | 2.40 | −0.71 | 3.11 | 2.57 |
| St Dev | | | | 0.00 | 0.01 | 0.22 | 0.07 | 0.29 | 0.14 |
| COC film | skin | 5 | 1 | 0.15 | 0.23 | 2.71 | −0.91 | 3.63 | 2.78 |
| COC film | skin | 5 | 2 | 0.16 | 0.24 | 2.20 | −0.66 | 2.86 | 2.50 |
| COC film | skin | 5 | 3 | 0.17 | 0.25 | 2.31 | −0.76 | 3.06 | 2.71 |
| Average | | | | 0.16 | 0.24 | 2.41 | −0.78 | 3.18 | 2.66 |
| St Dev | | | | 0.01 | 0.01 | 0.27 | 0.13 | 0.40 | 0.14 |

In Table 2, Ra is the average roughness as calculated over the entire measured array. Rq is the root-mean-squared roughness calculated over the entire measured array. Rt is the peak to valley difference calculated over the entire measured array. Rz is the average of the ten greatest peak to valley separations on the sample.

Layer 58 was stripped from the norbornene-based cyclic olefin optical body. The resulting optical body was treated with a nitrogen corona on Layer 52. This treatment was done using a corona energy of 2.5 J/cm². The optical body was coated using approximately 1-mil of a UV-curable acrylate composition, which was then pressed onto a patterned roll having a linear prismatic pattern. The prismatic coating was exposed to a UV cure source shortly after coating. The curing was done under a nitrogen atmosphere at 50 feet per minute web speed using Fusion D bulbs (F-600) at 100% power. Layer 54 was then removed from the optical body so formed and the optical body was then laminated to one side of a multilayer optical film, such as the multilayer reflective polarizer film DBEF available from 3M, using a 1-mil-thick, curable adhesive composition. Layer 58 was stripped from another norbornene-based cyclic olefin copolymer film and this film was adhered to the reverse side of the previously laminated DBEF film using the same curable adhesive having a 1-mil thickness. The formulation of the curable material is believed to contain a polymerizable nitrogen containing acrylate monomer and nitrogen-free polymerizable acrylate monomers.

The brightness gain (i.e. “gain”) of a particular optical film is the ratio of the transmitted light intensity with the optical film placed above a given backlight or light cavity, such as an illuminated Teflon light cube, compared to without the optical film. In particular, the transmitted light intensity of an optical film is measured with a SpectraScan™ PR-650 SpectraColorimeter available from Photo Research, Inc, Chatsworth, Calif. An absorptive polarizer also is placed in front of the SpectraScan™ PR-650 SpectraColorimeter. The particular optical film is then placed on the Teflon light cube. The light cube is illuminated via a light-pipe using a Fostec DCR II light source. With this configuration, the gain is the ratio of the transmitted light intensity as measured with the optical film versus with it removed. For optical films that incorporate a reflective polarizer, the polarization pass axis of the reflective polarizer is aligned parallel to the polarization pass axis of the absorptive polarizer. For the optical film described in this example, the linear prismatic microstructures are aligned at 45 degrees relative to the polarization pass axis of the absorptive polarizer. The gain of the optical film prototype was 2.313.

### Example 2

A three-layer, coextruded cast film was prepared, the general configuration of which is schematically illustrated in FIG. 4. The optical body 50 included a 1.5-mil-thick protective layer 54 of a glycol-modified polyester, Eastar 6763, from Eastman Chemicals containing 5% by weight of the same Topas® cyclic olefin copolymer that was used in Layer 52 of the construction. Layer 54 of the optical body 50 contained 5% by weight of the cyclic olefin copolymer material to modify the frictional properties of the skin layer 54. Coefficient of friction was determined for layer 54 in accordance with the procedures in ASTM D1894 using an I-MASS SP2000 slip-peel tester. For an unmodified layer of glycol-modified polyester, Eastar 6763, the coefficient of friction of the layer sliding over itself cannot be measured because the mechanism for sliding involves a stick-slip-type behavior. The sample sticks to itself until the sliding force builds to a high enough level to cause the test sled to jump in an uncontrolled manner. Using the cyclic olefin copolymer as an additive in layer 54, the coefficient of friction is approximately 0.46. This allows the film to easily slide on itself. The side of layer 52 in contact with layer 54 had a haze level of approximately 4%.

The norbornene-based cyclic olefin layer 52 of the optical body 50 was a 2.0-mil-thick layer of Topas® cyclic olefin copolymer available from Ticona (Celanese). The norbornene-based cyclic olefin layer 52 also contained 0.25% of Palmowax® ethylene bis stearamide (EBS) lubricant from Acme-Hardesty, Inc. The rough strippable skin layer 58 of optical body 50 was a 1.5-mil-thick layer of Eastar 6763 containing 5% by weight of Polybatch DUL3636DP12 blend from A. Schulman, Inc.

The three-layer film (optical body 50) was cast onto a chrome roll and was cooled to room temperature. The layers 58 and 54 were stripped from the norbornene-based cyclic olefin layer 52 to provide a cyclic olefin copolymer film having a haze level of 13%, as determined using a BYK-Gardner Hazegard Plus haze meter in accordance with the procedures described in ASTM D1003. The 180° peel force, as determined using the method described previously, required to peel the layer 58 from the norbornene-based cyclic olefin layer 52 was measured as 2.8 g/in.

Layer 58 was stripped from the norbornene-based cyclic olefin copolymer film. The resulting optical body was treated with a nitrogen corona on Layer 52. This treatment was done using corona energy of 2.0 J/cm². The optical body was coated using approximately 1-mil of a UV-curable acrylate composition, which was then pressed onto a patterned roll having a linear prismatic pattern. The prismatic coating was exposed to a UV cure source shortly after coating. The curing was done under a nitrogen atmosphere at 50 feet per minute web speed using Fusion D bulbs (F-600) at 100% power. Layer 54 was then removed from the optical body so formed and the optical body was then laminated to one side of a multilayer optical film, such as DBEF available from 3M, using a pressure-sensitive adhesive composition. Layer 54 was stripped from another norbornene-based cyclic olefin copolymer film and this film was adhered to the reverse side of the DBEF film using the same pressure-sensitive adhesive.

The brightness gain of this optical film prototype was 2.222.

### Example 3

In Example 3, the optical body of Example 1 was prepared exactly as described previously except that the lamination was accomplished using the pressure-sensitive adhesive composition of Example 2 instead of a curable resin adhesive composition. The brightness gain of this optical film prototype was 2.296.

### Example 4

A three-layer, coextruded cast film was prepared using extrusion conditions that provided less-intensive mixing compared with Examples 1 and 2. The general configuration of this film is shown schematically in FIG. 4. The optical body 50 included a 1.5-mil-thick protective layer 54 of a glycol-modified polyester, Eastar 6763, from Eastman Chemicals. The norbornene-based cyclic olefin layer 52 of the optical body 50 was a 2.0-mil-thick layer of Topas® cyclic olefin copolymer available from Ticona (Celanese). The norbornene-based cyclic olefin layer 52 also contained 0.25% of Palmowax® ethylene bis stearamide (EBS) lubricant from Acme-Hardesty, Inc. The rough strippable skin layer 58 of optical body 50 was a 1.5-mil-thick layer of Eastar 6763 containing from 10% to 40% by weight of Polybatch DUL3636DP12 blend from A. Schulman, Inc.

Table 3 summarizes the haze of Layer 52 after removal of Layer 58, as well as the 180° peel force for removing Layer 58 from Layer 52. The peel force shown in the table is for samples cut along the length or machine direction of the optical body.

TABLE 3

| | Haze of 52 Layer after | |
|---|---|---|
| | Removal of Skin | 180° Peel Force |
| Film Layer 58 Composition | Layers 58 from 52 (%) | (g/in) |
| 10% Polybatch | 5.0 | 2.8 |
| 20% Polybatch | 11.8 | 2.4 |
| 30% Polybatch | 34.0 | 4.2 |
| 40% Polybatch | 48.6 | 11.6 |

Layer 54 was removed from the optical body so formed and two pieces of the optical body were then laminated to opposing sides of a multilayer optical film, such as DBEF available from 3M, using a 1-mil-thick pressure-sensitive adhesive composition, as described in Example 2, to accomplish the lamination.

Laminates were prepared using two representative samples from Table 3. The haze and brightness gain of these laminates were determined using previously described procedures and these are reported in Table 4, Examples 4a and 4b.

TABLE 4

| | | Haze of | Brightness |
|---|---|---|---|
| | | Laminate | Gain |
| Example # | Film Layer 58 Composition | (%) | of Laminate |
| 4a | 20% Polybatch in Eastar 6763 | 25.9 | 1.663 |
| 4b | 40% Polybatch in Eastar 6763 | 72.8 | 1.612 |
| 5a | 20% Polybatch in Voridian 7352 | 73.3 | 1.649 |
| 6a | 10% Polybatch in Capron B85QP | 29.5 | 1.641 |

### Example 5

A three-layer, coextruded cast film was prepared, the general configuration of which is schematically illustrated in FIG. 4. The optical body 50 included a 1.5-mil-thick protective layer 54 of a poly(ethylene terephthalate) resin, Voridian 7352, from Eastman Chemicals. The norbornene-based cyclic olefin layer 52 of the optical body 50 was a 2.0-mil-thick layer of Topas® cyclic olefin copolymer available from Ticona (Celanese). The norbornene-based cyclic olefin layer 52 also contained 0.25% of Palmowax® ethylene bis stearamide (EBS) lubricant from Acme-Hardesty, Inc. The rough strippable skin layer 58 of optical body 50 was a 1.5-mil-thick layer of Voridian 7352 containing from 10% to 30% by weight of Polybatch DUL3636DP12 blend from A. Schulman, Inc.

Table 5 summarizes the haze of Layer 52 after removal of Layer 58, as well as the 180 peel force for removing Layer 58 from Layer 52. The peel force shown in the Table is for samples cut along the length or machine direction of the optical body.

TABLE 5

| Film Layer 58 | Haze of 52 Layer after | 180° Peel Force |
|---|---|---|
| Composition | Removal of Skin Layers(%) | 58 from 52 (g/in) |
| 10% Polybatch | 16.2 | 1.5 |
| 20% Polybatch | 48.2 | 4.8 |
| 30% Polybatch | 54.3 | 6.9 |

Layer 54 was removed from the optical body so formed and two pieces of the optical body were then laminated to opposing sides of a multilayer optical film, such as DBEF available from 3M, using a 1-mil-thick pressure-sensitive adhesive composition, as described in Example 2, to accomplish the lamination.

Laminates were prepared using a representative sample from Table 5. The haze and brightness gain of this laminate was determined using previously described procedures and these are reported in Table 4, Example 5a.

### Example 6

A three-layer, coextruded cast film was prepared, the general configuration of which is schematically illustrated in FIG. 4. The optical body 50 included a 1.5-mil-thick protective layer 54 of a nylon-6 resin, Capron B85QP, from BASF. The norbornene-based cyclic olefin layer 52 of the optical body 50 was a 2.0-mil-thick layer of Topas® cyclic olefin copolymer available from Ticona (Celanese). The norbornene-based cyclic olefin layer 52 also contained 0.25% of Palmowax® ethylene bis stearamide (EBS) lubricant from Acme-Hardesty, Inc. The rough strippable skin layer 58 of optical body 50 was a 1.5-mil-thick layer of Capron B85QP containing from 10% to 30% by weight of Polybatch DUL3636DP12 blend from A. Schulman, Inc.

Table 6 summarizes the haze of Layer 52 after removal of Layer 58, as well as the 180 peel force for removing Layer 58 from Layer 52. The peel force shown in the Table is for samples cut along the length or machine direction of the optical body.

TABLE 6

| Film Layer | Haze of 52 Layer after | 180° Peel Force |
|---|---|---|
| 58 Composition | Removal of Skin Layers(%) | 58 from 52 (g/in) |
| 10% Polybatch | 9.3 | 2.2 |
| 20% Polybatch | 23.6 | 5.2 |
| 30% Polybatch | 36.6 | 31.1 |

Layer 54 was removed from the optical body so formed and two pieces of the optical body were then laminated to opposing sides of a multilayer optical film, such as DBEF available from 3M, using a 1-mil-thick pressure-sensitive adhesive composition, as described in Example 2, to accomplish the lamination.

Laminates were prepared using a representative sample from Table 6. The haze and brightness gain of this laminate was determined using previously described procedures and these are reported in Table 4, Example 6a.

### Example 7

A three-layer, coextruded cast sheet was prepared, having a 6.0-mil-thick protective layer of a glycol-modified polyester, Eastar 6763, from Eastman Chemicals. The norbornene-based cyclic olefin layer of the optical body was an 8.0-mil-thick layer of Topas® cyclic olefin copolymer available from Ticona (Celanese). The norbornene-based cyclic olefin layer 52 also contained 0.25% of Palmowax® ethylene bis stearamide (EBS) lubricant from Acme-Hardesty, Inc. The rough strippable skin layer of the optical body was a 6.0-mil-thick layer of Eastar 6763 containing 5% by weight of Polybatch DUL3636DP12 blend from A. Schulman, Inc. The three-layer sheet was cast onto a chrome roll and was cooled to room temperature. This cast sheet was preheated to a temperature of 165° C. and was then stretched simultaneously at 2.1:1 machine direction (MD) by 2.1:1 tenter direction (TD) ratio.

The norbornene-based cyclic olefin layer had a thickness of 2.2 mil and a haze level of 2.5. The 180° peel force, as determined using the method described previously, required to peel the rough strippable skin layer from the norbornene-based cyclic olefin layer was measured as 3.1 g/in.

The rough strippable skin layer was stripped from norbornene-based cyclic olefin films and the optical bodies were then laminated to each side of a multilayer optical film, such as DBEF available from 3M. The lamination was done using a 1-mil-thick, curable adhesive composition on each side of the DBEF film. The formulation of the curable material is believed to contain a polymerizable nitrogen containing acrylate monomer and nitrogen-free polymerizable acrylate monomers. The brightness gain of this sample was 1.702.

### Example 8

A three-layer, coextruded cast film was prepared, the general configuration of which is schematically illustrated in FIG. 4. The optical body 50 included a 1.5-mil-thick protective layer 54 of a propylene homopolymer, PP3571, from Total Petrochemicals.

The norbornene-based cyclic olefin layer 52 of the optical body 50 was a 5.0-mil-thick layer of Topas® cyclic olefin copolymer available from Ticona (Celanese). The bornornene-based cyclic olefin layer 52 also contained 0.25% of Palmowax® ethylene bis stearamide (EBS) lubricant from acme-Hardesty, Inc. The rough strippable skin layer 58 of optical body 50 was a 1.5-mil-thick layer of PP3571 containing 30% by weight of high density polyethylene, MarFlex™ HHM TR-130 from Chevron Phillips Chemical.

The three-layer film (optical body 50) was cast onto a chrome roll and was cooled to room temperature. The layers 58 and 54 were stripped from the norbornene-based cyclic olefin layer 52 to provide a cyclic olefin copolymer film having a haze level of 40%, using the method described previously. The 180° peel force was measured by reinforcing each skin layer 54 and 58 with a piece of clear tape, Scotch® 355, and then using the method previously described. The required force to peel the layer 54 from the norbornene-based cyclic olefin layer 52 was measured as 328.3 g/in. The required force to peel the layer 58 from the norbornene-based cyclic olefin layer 52 was measured as 863.3 g/in.

### Example 9

In Table 7, various exemplary strippable skin blends are described. These blends were applied as a rough strippable skin layer and tested for ability to peel as generally described in Example 1. These blends were demonstrated to peel cleanly in sections from a norbornene-based cyclic olefin film layer (e.g., adhesion to the norbornene-based cyclic olefin film layer was low enough for removal). These rough strippable skins also imparted a desirable level of haze to the norbornene-based cyclic olefin layer based upon visual inspection. Such skins may be particularly useful for small areas.

TABLE 7

| Minor/Disperse Phase | Major/Continuous Phase |
|---|---|
| 10% high density polyethylene (MarFlex 9607XD from | 80% glycol-modified polyester |
| Chevron Phillips), | (Eastar 6763 from Eastman |
| 10% propylene homopolymer (Total 3571 from Total | Chemical |
| Petrochemicals),) | |
| 10% high density polyethylene (MarFlex 9607XD from | 80% glycol-modified polyester |
| Chevron Phillips), | (Eastar 6763 from Eastman |
| 10% polybutene-1 (PB 0300M from Basell Polyolefins) | Chemical) |
| 10% high density polyethylene (MarFlex 9607XD from | 80% polyethylene terephthalate |
| Chevron Phillips), | (Photo EC PET 65100 from 3M) |
| 10% propylene homopolymer (Total 3571 from Total | |
| Petrochemicals) | |
| 10% high density polyethylene (MarFlex 9607XD from | 80% polyethylene terephthalate |
| Chevron Phillips), | (Photo EC PET 65100 from 3M) |
| 10% polybutene-1 (PB 0300M from Basell Polyolefins) | |
| 10% propylene homopolymer (Total 3571 from Total | 80% polyethylene terephthalate |
| Petrochemicals), | (Photo EC PET 65100 from 3M) |
| 10% polybutene-1 (PB 0300M from Basell Polyolefins) | |

Other comparative examples include are provided in Table 8. The rough strippable skins described in Table 8, did not impart appreciable haze to the norbornene-based cyclic olefin layer. The rough strippable skins did demonstrate sufficient adhesion to the norbornene-based cyclic olefin layer and could be stripped cleanly.

TABLE 8

| Minor/Disperse Phase | Major/Continuous Phase |
|---|---|
| 5% nylon-6 (Capron B85QP from BASF) | 95% glycol-modified |
| | polyester (Eastar 6763 |
| | from Eastman Chemical) |
| 5% medium density polyethylene | 95% glycol-modified |
| (Marlex 9235 from Chevron Phillips) | polyester (Eastar 6763 |
| | from Eastman Chemical) |
| 20% medium density polyethylene (Marlex | 80% glycol-modified |
| 9235 from Chevron Phillips) | polyester (Eastar 6763 |
| | from Eastman Chemical) |
| 10% propylene homopolymer (Total 3571 from | 90% glycol-modified |
| Total Petrochemicals) | polyester (Eastar 6763 |
| | from Eastman Chemical) |

### Prophetic Example 10

A four-layer coextruded cast film can be prepared, the general configuration of which is schematically illustrated in FIG. 7. The multilayer film of FIG. 7 includes optical film 74, adhesive layer 73, a norbornene-based cyclic olefin layer 72 and strippable skin layer 78. Strippable skin layer 78 is operatively connected to one face of norbornene-based cyclic olefin layer 72, while the other (opposing) face of the norbornene-based cyclic olefin layer 72 is disposed with adhesive layer 73 upon one face of optical film 74. In a further embodiment, layers 73, 72 and 78 may be similarly disposed on both faces of the optical film 74, thereby creating a symmetrical optical body.

The norbornene-based cyclic olefin layer 72 of the optical body 70 can be a 2.0-mil-thick layer of Topas® cyclic olefin copolymer available from Ticona (Celanese AG). This layer 72 can also contain 0.25% of Palmowax ethylene bis stearamide (EBS) lubricant from Acme-Hardesty, Inc. The rough strippable skin layer 78 of the optical body 70 can be a 1.5-mil-thick layer containing a blend from 60% by weight to 95% of Eastar 6763 with from 5% to 40% of Polybatch DUL3636DP12 blend from A. Schulman, Inc. The Polybatch material is a 50%/50% blend of a random propylene copolymer and a medium-density polyethylene. The tie layer 73 can consist of polyolefins modified with maleic anhydride. An additional optical film layer 74 can be a multilayer optical film, such as DBEF, produced by coextrusion and orientation processing of PET as the first, high index material and coPET as the second, low index material.

Although the present invention has been described with reference to the exemplary embodiments specifically described herein, those of skill in the art will recognize that changes may be made in form and detail without departing from the spirit and scope of the present disclosure.

What is claimed is:

1. An optical body, comprising:
a norbornene-based cyclic olefin film layer; and
at least one rough strippable skin layer operatively connected to a surface of the norbornene-based cyclic olefin film layer, the at least one rough strippable skin layer comprising a continuous phase and a disperse phase.

2. The optical body of claim 1, wherein upon removal of the rough strippable skin layer the surface of the norbornene-based cyclic olefin film layer is characterized by a haze of from about 5% to 95%.

3. The optical body of claim 1, wherein the disperse phase comprises a polymer that is substantially immiscible in the continuous phase.

4. The optical body of claim 3, wherein the at least one rough strippable skin further comprises a nucleating agent.

5. The optical body of claim 3, wherein the polymer of the disperse phase has a crystallinity that is higher than a crystallinity of the continuous phase.

6. The optical body of claim 1, wherein the disperse phase comprises at least one of: an inorganic material, styrene acrylonitrile copolymer, polystyrene, medium density polyethylene, modified polyethylene, polybutene-1, polycarbonate and copolyester blend, norbornene-based copolymers, ε-caprolactone polymer, propylene homopolymer, propylene random copolymer, poly(ethylene octene) copolymer, polymer exhibiting antistatic characteristics, high density polyethylene, linear low density polyethylene and poly(methyl methacrylate).

7. The optical body of claim 1, wherein the continuous phase comprises at least one of: polyethyleneterephthalate (PET), polybutyleneterephthalate (PBT); glycol-modified polyethyleneterephthalate (PETG); polyethylenenapththalates (PENs) and copolyethylenenapththalates (CoPENs); nylon-6; polycarbonates and polycarbonate blends; syndiotactic polypropylene; propylene homopolymer; linear low density polyethylene and randon copolymer of propylene and ethylene.

8. The optical body of claim 1, wherein the optical body further comprises an optical film attached to the norbornene-based cyclic olefin film layer, said optical film being selected from the group consisting of: a multilayer polarizer, a multilayer reflector, a diffuse reflective polarizer having a continuous phase and a disperse phase, a layer comprising styrene acrylonitrile, a layer comprising polycarbonate, a layer comprising PET, a layer comprising curable material, a layer comprising a cycloaliphatic polyester/polycarbonate and any number or combination thereof.

9. The optical body of claim 8, wherein the optical film is attached to the norbornene-based cyclic olefin film layer by a tie layer.

10. The optical body of claim 1, wherein the optical body comprises at least two rough strippable skin layers.

11. The optical body of claim 1, wherein the rough strippable skin layer further comprises a coloring agent.

12. The optical body of claim 1, said optical body being substantially transparent.

13. The optical body of claim 1, further comprising at least one smooth outer skin layer disposed over the at least one rough strippable skin layer.

14. The optical body of claim 1, wherein the norbornene-based cyclic olefin film layer further comprises a lubricant.

15. An optical body, comprising:
a norbornene-based cyclic olefin film layer; and
at least one rough strippable skin layer operatively connected to the norbornene-based cyclic olefin film layer, the at least one rough strippable skin layer comprising:
a first polymer,
a second polymer different from the first polymer,
and an additional material that is substantially immiscible in at least one of the first and second polymers.

16. The optical body of claim 15, wherein the first polymer has a crystallinity that is lower than a crystallinity of the second polymer.

17. The optical body of claim 15, wherein the first polymer is selected from the group consisting of: polyethyleneterephthalate (PET), polybutyleneterephthalate (PBT); glycol-modified polyethyleneterephthalate (PETG); polyethylenenapththalates (PENs) and copolyethylenenapththalates (CoPENs); nylon-6; polycarbonates and polycarbonate blends; syndiotactic polypropylene, polypropylene homopolymer, linear low density polyethylene and random copolymer of propylene and ethylene.

18. The optical body of claim 15, wherein the second polymer is selected from the group consisting of: styrene acrylonitrile copolymer, polystyrene, medium density polyethylene, modified polyethylene, polycarbonate and copolyester blend, norbornene-based copolymers, polybutene-1, ε-caprolactone polymer, propylene random copolymer, poly(ethylene octene) copolymer, anti-static polymer, high density polyethylene, linear low density polyethylene and polymethyl methacrylate.

19. The optical body of claim 15, wherein the additional material substantially immiscible in at least one of the first and second polymers comprises a third polymer.

20. The optical body of claim 19, wherein the third polymer is selected from the group consisting of: styrene acrylonitrile copolymer, polystyrene, medium density polyethylene, modified polyethylene, polycarbonate and copolyester blend, norbornene-based copolymers, polybutene-1, ε-caprolactone polymer, propylene homopolymer, propylene random copolymer, poly(ethylene octene) copolymer, polymer exhibiting anti-static characteristics, high density polyethylene, linear low density polyethylene and poly(methyl methacrylate).

21. The optical body of claim 15, wherein the material substantially immiscible in at least one of the first and second polymers includes inorganic material.

22. A method of imparting haze to a norbornene-based cyclic olefin film layer comprising:
operatively connecting at least one rough strippable skin layer to the norbornene-based cyclic olefin film, wherein the rough strippable skin layer comprises a continuous phase and a disperse phase; and
imparting a texture corresponding to a texture of the rough strippable skin layer to the norbornene-based cyclic olefin layer.

23. The method of claim 22, further comprising:
stripping the rough strippable skin layer from the norbornene-based cyclic olefin layer, wherein the exposed surface of the norbornene-based cyclic olefin layer is characterized by a haze of from about 5% haze to 95%.

24. The method of claim 23, wherein the haze of the norbornene-based cyclic olefin film layer is from about 10% to about 30%.
